(19) United States
(12) Patent Application Publication
(10) Pub. No.: US 2006/0042363 A1
(43) Pub. Date: Mar. 2, 2006

(54) Method for detecting corrosion in industrial process equipment

(75) Inventors: Merwyn E. Howells, Prairieville, LA (US); Bruce R. Sitar, Baton Rouge, LA (US); Michael E. Reames, Prairieville, LA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 11/072,546

(22) Filed: Mar. 4, 2005

Related U.S. Application Data
(60) Provisional application No. 60/605,006, filed on Aug. 27, 2004.

(51) Int. Cl. G01M 3/02; G01N 17/00

(52) U.S. Cl. 73/86; 73/37

(57) ABSTRACT

A method for detecting corrosion in a vessel comprising providing within the vessel a tube having a wall thickness selected to allow corrosion to penetrate fully through the tube before that amount of corrosion exceeds the corrosion allowance of the vessel, the tube comprising a pressure sensor to detect a change in the tube's internal pressure once the tube is penetrated by corrosion anywhere along its length.

### RELATED APPLICATIONS

This patent application claims priority under 35 U.S.C. § 119(e) to U.S. provisional patent application Ser. No. 60/605,006, filed Aug. 27, 2004.

### FIELD OF THE INVENTION

The present invention relates to the detection of corrosion in the interior of industrial process equipment. In particular, the present invention provides a method of estimating or detecting corrosion in industrial process equipment so as to allow corrective action before the corrosion penetrates the wall of the process equipment, thereby preventing the leakage of hazardous material into the surrounding environment.

### BACKGROUND OF THE INVENTION

Corrosion in industrial and process installations is a major and continuous problem, particularly in chemical plants and petroleum refineries. Corrosion activity occurs within operating process machinery and transport lines to varying degrees depending upon numerous factors, including the corrosivity of the process stream and its condensates, the temperature of the process, process velocities, and the metallurgy of the equipment employed in the process. Such corrosion activity can adversely affect the performance of process equipment, reduce the useful life of equipment and lines, and necessitate costly maintenance, repair and replacement of system components. If undetected, corrosion can cause leaks in the vessels and/or process machinery that can lead to severe human and environmental risks. Consequently, corrosion reduction, or at least the mitigation of the effects of corrosion, is a continuing concern in many industrial settings including the chemical and refinery industries.

One prevalent source of corrosion is liquid in reaction vessels. Another is process vapors and materials entrained in vapor flow. Many process vapor streams contain corrosive components that initiate corrosion upon condensation or deposition. For example, aqueous condensation leads to much of this corrosion activity and occurs frequently in heat exchange units and transport lines. The effects of such corrosion can be mitigated through the implementation of a corrosion control program that may include the use of corrosion inhibiting chemicals. However, the design, implementation, and optimization of such a program is frequently costly and usually requires information on the corrosion activity itself.

A number of methods are known for collecting information on the nature of corrosion activity caused by process vapors and vapor condensates and on the process parameters affecting the initiation and propagation of corrosion. It is known, for instance, to insert corrosion probes into a process stream by mounting the probes directly in the process machinery or lines. For example, in U.S. Pat. No. 3,720,818, a stylus, electrically connected to a transducer consisting of two symmetrical coils, is moved along a surface. As the stylus moves normal to the surface changes of inductance in the transducer coils are measured and utilized as a signal of surface roughness. In U.S. Pat. No. 3,580,062 a feeler point is moved along the surface of a work piece to measure roughness. The feeler point is mechanically connected to an electromechanical transducer for converting the relative movement of the feeler point and the work piece into an electrical signal. Corrosion detection techniques based on similar mechanical and electronic principles are disclosed in the following: U.S. Pat. No. 3,973,441 discloses use of a pipeline pig is electrically coupled to an accelerometer to measure change in pipe diameter; U.S. Pat. No. 4,295,092 discloses a probe for measuring the variance in capacitance as indicia of corrosion; U.S. Pat. No. 4,301,677 discloses cantilever springs coupled to a strain gauge undulations in the internal surface of a pipe; U.S. Pat. No. 4,341,113 discloses flexure springs to measure tube abnormalities through a strain gauge. All of these devices, however, require sophisticated and sensitive measuring instruments to detect internal surface abnormalities and, therefore, are relatively costly and cumbersome to use. Moreover, Applicants have come to appreciate another drawback or deficiency of these methods; the probe or instrument placement will not necessarily correspond to the actual point of the worst corrosion activity, which often changes over time depending upon variations in process parameters.

Another method of detecting the degree of corrosion damage in chemical process equipment such as, for example, heat exchangers, is known as the eddy current type flaw detecting method. This method is extensively employed for austenite stainless steel pipes and brass pipes. This method is described in “Ishikawajima-Harima Engineering Review”, Vol. 18, No. 1 (January 1978), pp. 38-41. The eddy current method uses an exciting coil and a detecting coil; flaws in a pipe are detected according to a pulse signal outputted by the detecting coil, or in variations in the impedance thereof. This system, however, is disadvantageous in that the output signal does not correspond to the depth of a portion of the pipe damaged by corrosion. In addition, if the pipe to be inspected is made of a magnetic material, e.g., steel, it must first be magnetically saturated, usually by inserting a coil carrying an electric current into the tubes, which involves considerable difficulty.

All of the above processes require shutting down, depressurizing, and opening the equipment.

Electrical resistance (ER) corrosion probes are also used in petroleum, chemical processing, and other environments where on-line corrosion rate readings are required. The operating principle is based on the change in resistance of the probe element as it is exposed to corrosive conditions. This method, like the other methods identified above, is only capable of measuring corrosive activity locally, i.e., at the point of the probe.

An additional method to access corrosion damage is external ultrasonic thickness gauging, for example, as described in the recommended practice of the American Petroleum Institute API RP 579, “Recommended Practice for Fitness for Service.” Although ultrasonic thickness gauging is useable while equipment is in operation, it has a number of limitations. Significantly, for example, it is not able to measure the full surface of a vessel because it is a “spot” measurement technique. In this regard, since it requires access to the outer surface of the vessel, any obstruction such as a steam jacket or insulation greatly reduces the locations available for inspection.

Another method for determining corrosion activity of process vapors and condensates is simulation. As used in the present context, simulation refers to physical testing and analysis. In known corrosion simulators, a slip stream of process vapor is diverted and passed through a simulator circuit consisting in a pre-piped bank of condensing areas or chambers. Water cools the vapor stream and causes aqueous condensation within the simulator. Corrosion probes, weight loss coupons, and condensate samples are then used to evaluate the location, type, and rate of corrosion taking place in the simulator. Corrosion activity is then related to the corrosion actually occurring or expected in the actual process machinery from which the slip stream was taken.

Corrosion simulators, however, have a number of drawbacks. The pre-piped arrangement of the cooling coil and water box, for example, limit the adaptability of the simulator to a particular simulation application. The operation of corrosion simulators is also expensive and labor intensive. Most significantly, the use of a corrosion simulator cannot give an operator a “real time” indication of the state of the actual equipment so the operator has no way of knowing where in the actual equipment there is a potential for catastrophic failure.

Accordingly, applicants have come to appreciate the need for a simple, reliable, and low-cost method of detecting corrosion in industrial, chemical, and refinery process equipment at the point where the most severe corrosion has occurred during operation of the equipment.

### SUMMARY OF THE INVENTION

One aspect of the present invention provides a method for detecting corrosion in process equipment containing corrosive fluid before corrosion caused by said fluid causes a leak of said corrosive fluid through a wall of the equipment. The initial occurrence of such a leak is sometimes referred to herein as “breakthrough.” Preferred methods comprise providing within the process equipment a walled container, such a tube, in which at least a portion of the wall of the container has a thickness which will experience breakthrough as a result of corrosion by the corrosive fluid before, and preferably substantially before, the corrosion allowance of the process equipment is exceeded. The methods preferably comprise providing a pressure sensor to detect a change in the tube's internal pressure of the walled container once the tube is penetrated by corrosion.

Another aspect of the present invention provides improved process equipment, such as heat exchangers, processing tanks, distillation columns, reactors and the like. Preferred process equipment comprises a vessel for containing a fluid that is at least potentially corrosive, a walled container located at least partially within the vessel, at least a portion of the wall of the container having a thickness such that breakthrough of said portion of the wall will occur as a result of corrosion by the corrosive fluid before, and preferably substantially before, the corrosion allowance of the process equipment is exceeded. Preferably a pressure sensor is in operative association with the walled container so as to detect a change in the internal pressure of the walled container once said portion of the wall of the container is penetrated by corrosion.

In certain preferred embodiments, the walled container of the present invention is configured to permit monitoring of corrosion conditions at numerous locations within the vessel.

### BRIEF DESCRIPTION OF THE DRAWINGS

The foregoing summary, as well as the following detailed description of the preferred embodiments, may be better understood when they are read in conjunction with the appended drawings. The drawings illustrate preferred embodiments of the invention to exemplify various aspects of the invention. The invention, however, should not be considered to be limited to the specific embodiments that are illustrated and disclosed. In the drawings:

FIG. 1 is an example of a vessel suitable for use in accordance with the present invention;

FIG. 2 is a cross-sectional view taken through line A-A of the vessel of FIG. 1, showing a tube sheet modified according to the present invention;

FIG. 3 is a cross-sectional view taken through line B-B of the tube sheet of FIG. 2, modified according to the present invention;

FIG. 4 is a side view of the tube sheet of FIG. 2 as modified by the present invention;

FIG. 5 is a side view of a pressure tap assembly according to the present invention;

FIG. 6 is a side view of a nipple component of the pressure tap assembly of FIG. 5 according to the present invention;

FIG. 7 is a plan view of a vessel constructed in accordance with the present invention; and

FIG. 8 illustrates another embodiment of the present invention.

### DETAILED DESCRIPTION OF THE INVENTION

The present invention provides, in one aspect, a method for detecting corrosion in, and thereby protecting, chemical process equipment such as, for example, heat exchangers, reactors, piping, condensers, and processing tanks. Such equipment generally comprises a vessel. It will be appreciated by those skilled in the art that, as used herein, the term “vessel” includes any process equipment that may contain corrosive materials (e.g., fluids) and, therefore, are at risk of leaking or other structural failure as a result of corrosion. It will also be appreciated by those skilled in the art that, as used herein, the term “fluid” as it related to materials means a substance that is capable of flowing such as, for example, a liquid or a gas.

The present invention preferably provides methods for detecting corrosion in process equipment containing corrosive fluid before corrosion caused by said fluid causes a leak of said corrosive fluid through a wall of the equipment. The initial occurrence of such a leak is sometimes referred to herein as “breakthrough.” Preferred methods comprise providing within the process equipment a walled container, such as a tube, in which at least a portion of the wall of the container has a thickness that will experience breakthrough as a result of corrosion by the corrosive fluid before, and preferably substantially before, the corrosion allowance of the process equipment is exceeded. The methods preferably comprise providing a pressure sensor in operative association with the walled container to detect a change in the internal pressure of the walled container once the wall of the container is penetrated by corrosion.

In other preferred embodiments, the present invention provides methods for preventing a leak through the wall of a vessel containing corrosive material in a chemical process comprising providing within the vessel a walled container comprising a tube having a wall thickness selected to allow corrosion to penetrate through the tube and thereby provide an indication that a corrosion severity has been reached. Preferably, the given corrosion severity is selected to be lower than the corrosion allowance of the vessel. In preferred embodiments, the step of indicating that the corrosion severity has been reached comprises providing a pressure sensor in fluid communication with the interior of the tube to detect a change in the tube's internal pressure once the tube is penetrated by corrosion. Upon or subsequent to the detection of penetration, the preferred methods further comprise alerting the operator to allow modification of process conditions to prevent premature breakthrough of the vessel.

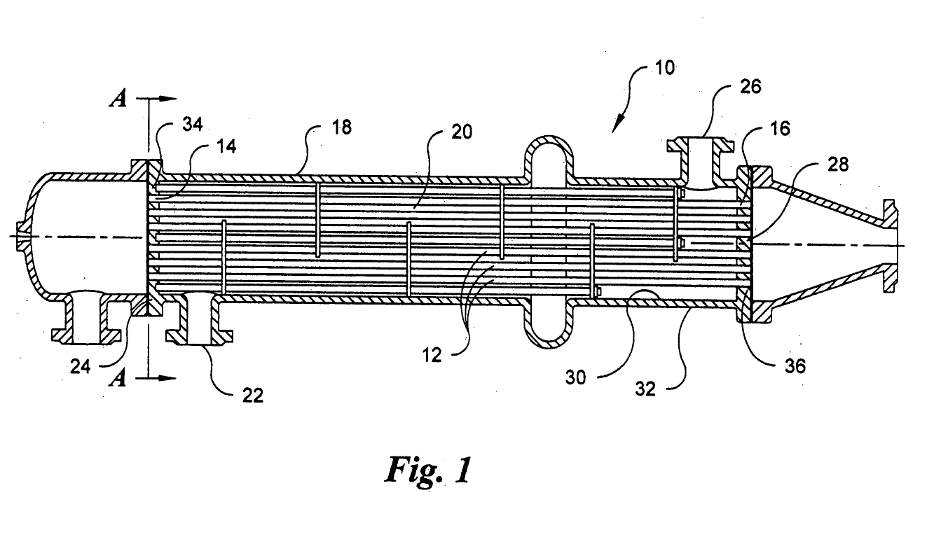

FIGS. 1-7 illustrate one embodiment of the invention. Referring to FIG. 1, vessel 10 is an industrial heat exchanger such as, for example, a shell-and-tube bundle-type heat exchanger for transferring heat between a first and second fluid. Vessel 10 may be a condensation heat exchanger such as those used in, for example, a distillation process. Preferably, vessel 10 is made of a corrosion-resistant material.

Referring to FIG. 1, vessel 10 comprises a plurality of elongated tubes 12 for flow therethrough of a first fluid through the tubes. Each tube of the plurality of elongated tubes 12 has a first end 14 and a second end 16, each of said tubes having an inner tube surface (shown in cross section) and an outer tube surface (shown in cross-section) and wherein the thickness of each tube is defined by the distance between the inner tube surface and the outer tube surface. Vessel 10 further comprises an outer shell 18 formed by walls surrounding and defining therein a heat transfer space 20 for the second fluid to flow about and in contact with said outside surface of the plurality of elongated tubes 12 which extend through the heat transfer space 20. Outer shell 18 further has at least one inlet opening 22 in an inlet end portion 24 for receiving the second fluid therethrough and at least one outlet opening 26 in an outlet end portion 28 for discharging the second fluid therethrough. Outer shell 18 has an inner shell surface 30 and an outer shell surface 32 wherein the thickness of said outer shell is defined by the distance between said inner shell surface and said outer shell surface. Vessel 10 further comprises a first transverse member (e.g., tubesheet) 34 coupled to inlet end portion 24 of inner shell surface 30 of outer shell 18 for supporting first end 14 of tubes 12. First transverse member 34 defines a plurality of apertures (not shown) for receiving respective first end 14 of each of the plurality of elongated tubes 12. A second transverse member 36 is coupled to outlet end portion 28 of inner shell surface of outer shell 18 for supporting the second end 16 of each of the plurality of elongated tubes 12. Second transverse member 36 defines a plurality of apertures (not shown) for receiving respective second end 16 of each of the plurality of elongated tubes 12. Although FIG. 1 illustrates a shell-and-tube bundle-type heat exchanger, it will be appreciated that the present invention may be embodied in any type of heat exchanger, including, for example, a U-tube bundle-type heat exchanger.

It will be appreciated by those skilled in the art that the first and second fluids may be either liquid or gas, or mixtures thereof. In preferred embodiments, the first and second fluids are liquid or gases, one of which is condensing in heat transfer space 20. In more preferred embodiments, the second fluid is corrosive or at least potentially corrosive.

When the present invention is embodied in a heat exchanger bundle, a specific single tube or a set of tubes may be modified according to the present invention to sense various locations within the bundle where corrosion may occur. A typical heat exchanger that can be modified according to the present invention is an overhead condenser and is typically anywhere from eight to sixteen feet in length.

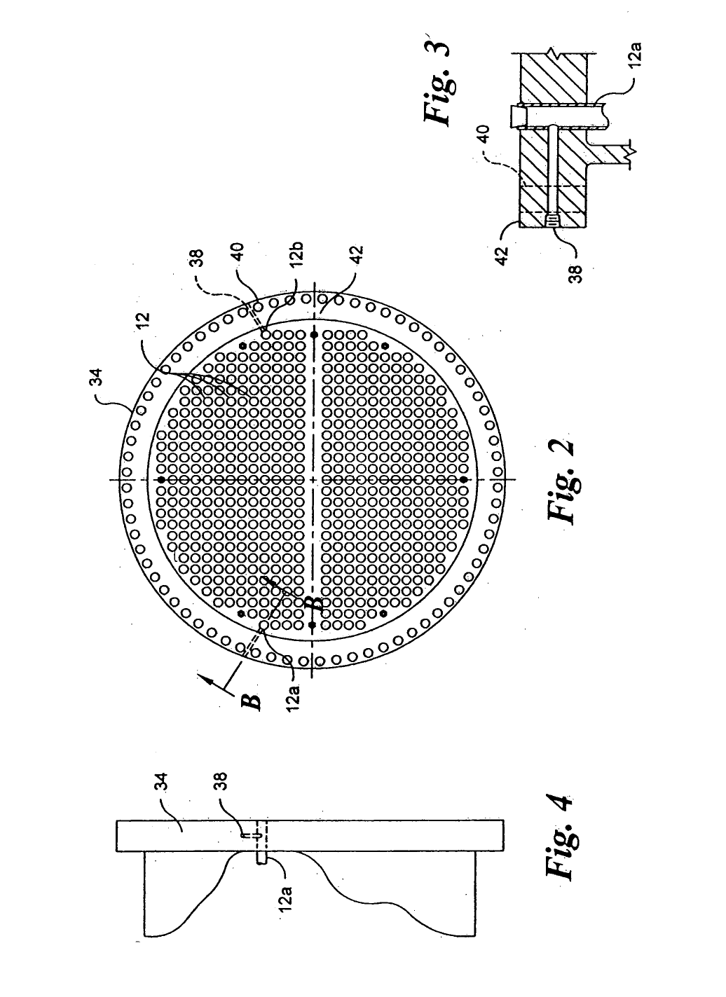

Referring now to FIG. 2, a cross-sectional view of, for example, first transverse member 34 housing a plurality of elongated tubes 12 is shown. To modify vessel 10 according to the present invention, selected tubes 12a and 12b, for example, are typically plugged as a means to create an internal pressure that is different from the vessel to be protected (i.e., vessel 10). Tubes may be selected to sense various locations within, for example, a heat exchanger bundle where corrosion is likely to occur. The pressure within the selected tubes 12a and 12b can be either higher or lower than the pressure of the vessel to be protected. In preferred embodiments, the pressure inside selected tubes 12a and 12b is lower than that of the vessel to be protected. Selected tubes 12a and 12b can be plugged by any means known to those skilled in the art. For example, selected tubes 12a and 12b can be sealed with mechanically installed plugs. Alternatively, unthreaded plugs having an O.D. slightly less than selected tubes 12a and 12b can be driven into the apertures of selected tubes 12a and 12b such that they are maintained by forces of friction.

Preferably, selected tubes 12a and 12b are selected to be sacrificed in the presence of a corrosion source preferentially over the walls of the vessel in which they are contained. Accordingly, in a preferred embodiment of the present invention, the walls of selected tubes 12a and 12b may be made out of the same or essentially the same alloy as the vessel to be protected but are thinner than the vessel to allow corrosion to penetrate fully through the tube before that amount of corrosion exceeds the corrosion allowance of the vessel. Thus, for example, the walls of selected tubes 12a and 12b may be thinner than, but made out of the same alloy as tubular shell 12.

In another preferred embodiment, the walls of selected tubes 12a and 12b may be as thick as or even thinner than the walls of the vessel to be protected, but may be made out of a less corrosion resistant material such as, for example carbon steel in an alloy unit, to allow for an even earlier warning.

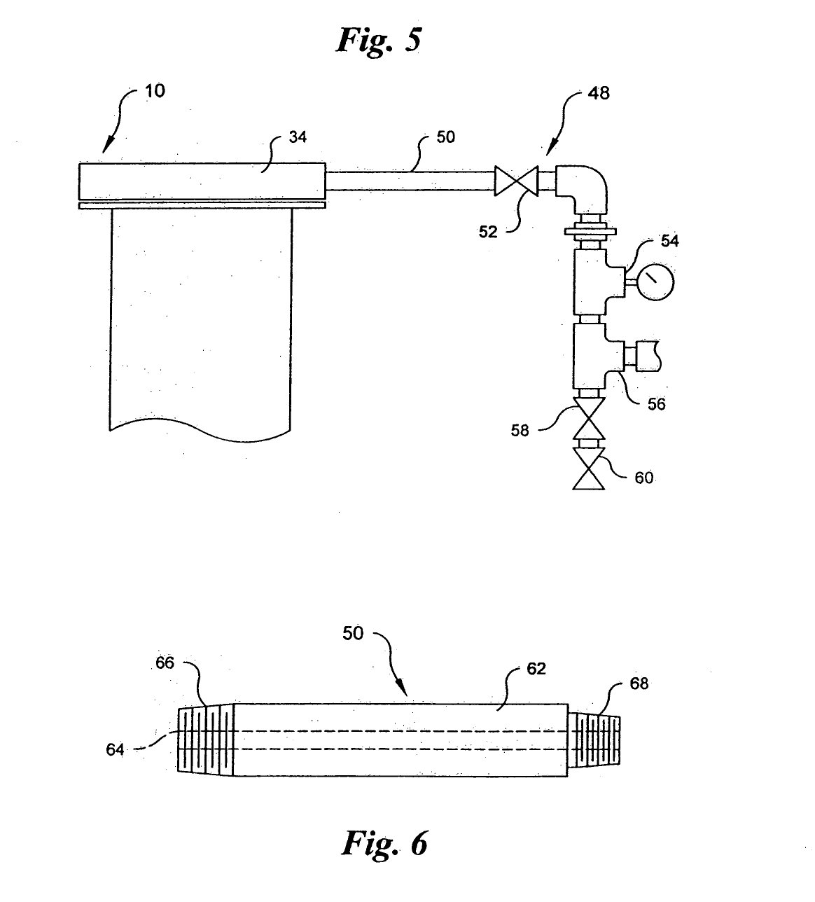

Still referring to FIG. 2, a channel 38 is drilled transversely first transverse member 34 into one or more of selected tubes 12a and 12b as a means to connect selected tubes 12a and 12b to the space outside the equipment where a monitoring device can be installed. As shown in FIG. 2, channel 38 is preferably drilled between bolt holes 40 on flange 42. Preferably, channel 38 is also drilled between any groove rolls that may be present on the equipment (not shown). Any drilling means known to those skilled in the art can be used in accordance with the present invention. FIG. 3 shows an expanded view of channel 38 in flange 42 through to selected tube 12a. FIG. 4 shows a cross-sectional view of the first transverse member 34 of FIG. 2 as modified by the present invention with channel 38. The diameter of the channel 38 is not critical to the present invention but it should be large enough to be tapped to mate with a pressure tap assembly as shown in FIGS. 5-7. Although FIGS. 2-4 illustrate channel 38 located through the flange 42 of first transverse member 34, it will be appreciated that channel 38 can be located at any position along vessel 10 as long as the selected tube can be accessed.

According to the present invention, a pressure sensor is provided in operative association with at least one of selected tubes 12a and 12b to detect a change in the internal pressure of the selected tube. In a preferred embodiment, this is accomplished through the use of a pressure tap assembly.

FIGS. 5-7 illustrate the pressure tap assembly 48 according to the present invention. Referring now to FIG. 5, pressure tap assembly 48 comprises, for example, nipple 50, isolation valve 52, pressure sensor (gauge) 54, pressure sensor (switch) 56, and valves 58 and 60. In a preferred embodiment, a special strengthened nipple 50 is employed such as, for example, the nipple illustrated in FIG. 6.

Referring now to FIG. 6, nipple 50 comprises a section of metal bar stock 62, preferably 1″ in diameter (O.D.), drilled through its longitudinal axis with a small bore hole 64. Preferably, the small bore hole is ¼″ for a 1″ O.D. nipple. Nipple 50 is then threaded to fit into the drilled and tapped hole on the equipment to be protected on one end 66 and to the isolation valve 52, for example, on the other end 68. This arrangement provides a strengthened connection between an otherwise fragile assemble and a normally heavy heat exchanger or other pressure vessel.

Referring now to FIG. 5, nipple 50 is in fluid connection with the vessel 10 and selected tube 12a (not shown) through channel 38. On the downstream side of nipple 50, isolation valve 52 typically serves to isolate the contents of the heat exchanger in, for example, the event that a leak is detected within selected tube 12a. In preferred embodiments, a pressure senor is a component of pressure tap assembly 48 and is preferably coupled to the isolation valve 52. A pressure sensor according to the present invention is preferably located downstream of isolation valve 52 and can consist of either pressure gauge 54, pressure switch 56, or both as is shown in FIG. 5. The pressure sensor functions to detect a change in the pressure within a selected tube such as that that would occur as a result of corrosion penetrating the selected tube. Pressure gauge 54 is typically a localized pressure gauge and is readable by an operator upon visual inspection. In preferred embodiments, a pressure switch 56 is attached to the pressure tap assembly 48. Pressure switch 56 is preferred because it allows the assembly to be integrated with an automated monitoring system such as, for example, a distributed control system such as, for example, the EXPERION PROCESS KNOWLEDGE SYSTEM™ made by Honeywell International, Inc. (Morristown, N.J.). In a preferred embodiment, the distributed control system is in operative association with the pressure sensor. A pressure switch suitable for use in the present invention is, for example, the Mini-Hermet pressure switch made by SOR (Lenexa, Kans.).

In another preferred embodiment of the invention, the pressure sensor alerts the equipment controller of a change in pressure within the selected tube (caused by corrosion) by either an audible alarm or by sending an electric signal to the controller via the distributed control system or both so that the controller can quickly stop the operation and modify process conditions to prevent premature breakthrough of the vessel. It will be appreciated by those skilled in the art that the term “modify process conditions” will be understood to refer to any number of remedial actions that can be taken to extend the useful life of the vessel and/or to prevent premature breakthrough of corrosive material through the walls of the vessel. For example, such remedial activity may include modifying process conditions such as pH, temperature, or the concentration of the corrosion-causing process fluid; modifying the vessel such as, for example, adding a corrosive-resistant coating; and replacing the vessel itself.

Still referring to FIG. 5, optional valves 58 and 60 allow for drainage of material in a controlled manner.

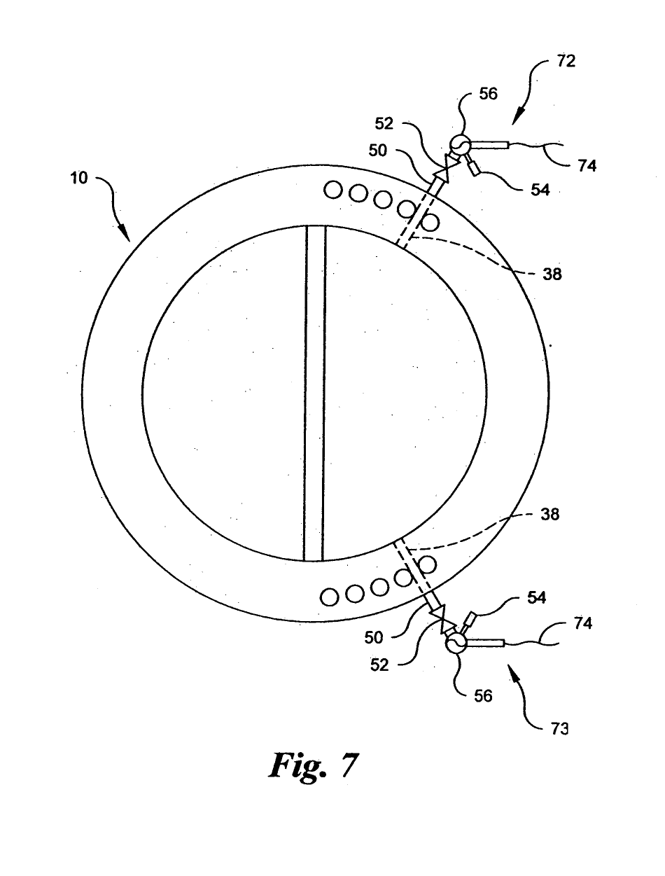

FIG. 7 is a top plan view of an embodiment of the present invention. In FIG. 7, vessel 10 is shown with two assemblies 72, 73 according to the present invention on their respective selected tubes 12a and 12b (not shown). Nipple 50 is shown in fluid connection with channel 38. Attached to nipple 50 is isolation valve 52 which, in turn, is in fluid connection with pressure gauge 54 and pressure switch 56. Pressure switch 56 is integrated with a distributed control system via line 74.

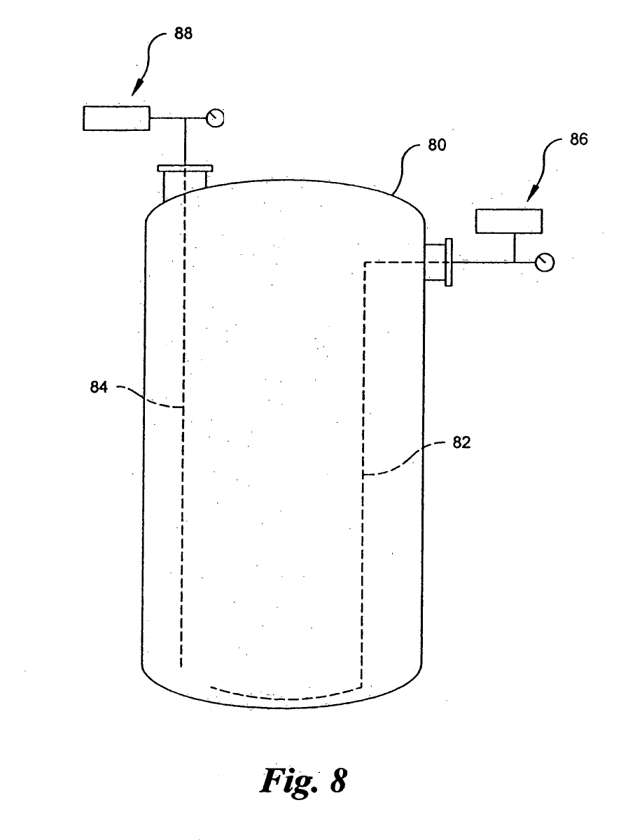

FIG. 8 shows another embodiment in which vessel 80 is protected according to the invention. FIG. 8 demonstrates that tubes according to the present invention can be positioned in a variety of ways within the equipment to be protected depending upon where corrosion is likely to occur. Tube 82, for example, runs along the bottom of the vessel as well as the side. Tube 84 only runs along the length of the vessel. The vessel may be fixed with one or more tubes according to the present invention. In this embodiment, the tubes are plugged such as to create a pressure differential relative to that inside the vessel as described above. An assembly 86, 88 is affixed to each of the tubes that includes, for example, a pressure sensor as described above.

Although the invention has been described with respect to various preferred embodiments, it is not intended to be limited thereto, but rather those skilled in the art will recognize that variations and modifications may be made therein which are within the spirit of the invention and the scope of the appended claims.

What is claimed is:

1. A method for detecting corrosion in a vessel containing corrosive process fluid comprising:
providing a walled container within the vessel, at least a portion of said container having a wall thickness selected to allow corrosion caused by said corrosive process fluid to penetrate through said wall thickness before the corrosion caused by the process fluid exceeds the corrosion allowance of the vessel anywhere along the length of the vessel;
providing a sensor for indicating the pressure in said walled container;
monitoring the pressure indicated by said sensor to detect corrosive breakthrough of said walled container.

2. The method of claim 1 wherein said walled container is an elongate container.

3. The method of claim 2 wherein said elongate container is a tube.

4. The method of claim 3 wherein said wall thickness is less than the wall thickness of the vessel.

5. The method of claim 1 wherein the vessel and said container are formed from substantially the same material.

6. The method of claim 1 wherein the vessel and the container are each formed from a corrosion-resistant alloy.

7. The method of claim 6 wherein said container is made of an alloy having a lesser resistance to corrosion than the alloy of the vessel.

8. The method of claim 7 wherein said wall thickness is less than the wall thickness of the vessel.

9. The method of claim 1 wherein said pressure sensor is operatively associated with a distributed control system.

10. The method of claim 7 wherein said pressure sensor comprises a pressure switch.

11. The method of claim 1 wherein the vessel comprises a heat exchanger.

12. The method of claim 1 wherein the vessel comprises a processing tank.

13. A method for detecting corrosion in chemical process equipment comprising:
providing a vessel containing therein a corrosive material;
providing within the vessel a tube, at least a portion of said tube having a wall thickness selected to allow corrosion from said corrosive material to penetrate said wall thickness before corrosion form said corrosive material exceeds the corrosion allowance of the vessel
providing a pressure sensor in operative association with said tube to detect a change in the internal pressure of said tube;
a distributed control system in operative association with said pressure sensor; and
sending a signal through the distributed control system to detect a change in the tube's internal pressure.

12. The method of claim 11 wherein the wall thickness of said portion of the tube is less than the wall thickness of the vessel.

13. The method of claim 11 wherein said tube is made of substantially the same alloy as the vessel.

14. The method of claim 12 wherein said tube is made of substantially the same alloy as the vessel.

15. The method of claim 11 wherein said tube is made of an alloy having a lesser resistance to corrosion than the alloy of the vessel.

16. The method of claim 15 wherein the wall thickness of said portion of the tube is less than the wall thickness of the vessel.

17. The method of claim 11 wherein said pressure sensor includes a pressure switch.

18. The method of claim 11 wherein the vessel comprises a heat exchanger.

19. The method of claim 11 wherein the vessel comprises a processing tank.

20. A method for preventing a leak through the wall of a vessel containing corrosive material in a chemical process comprising:
a) providing within the vessel a tube having a wall thickness selected to allow corrosion to penetrate fully through the tube before that amount of corrosion exceeds the corrosion allowance of the vessel;
b) providing a pressure sensor in fluid communication with the tube to detect a change in the internal pressure of said tube once said portion of the tube wall is penetrated by corrosion; and
c) upon or subsequent to the detection of penetration in step (b), modifying process conditions to prevent premature breakthrough of the vessel.

21. The method of claim 20 wherein the wall thickness of the tube is less than the wall thickness of the vessel.

22. The method of claim 20 wherein the tube is made of the same alloy as the vessel.

23. The method of claim 21 wherein the tube is made of the same alloy as the vessel.

24. The method of claim 20 wherein the tube is made of an alloy with a lesser resistance to corrosion than the alloy of the vessel.

25. The method of claim 24 wherein the wall thickness of the tube is less than the wall thickness of the vessel.

26. The method of claim 20 wherein the pressure sensor is integrated with a distributed control system.

27. The method of claim 20 wherein the vessel is a heat exchanger.

28. The method of claim 20 wherein the vessel is a processing tank.

29. The method of claim 20 wherein the pressure sensor includes a pressure switch.

30. A heat exchanger for transferring heat between a first and second fluid comprising a plurality of elongated tubes for flow therethrough of said first fluid through said tubes, each tube having a first end and a second end, each of said tubes having an inner tube surface and an outer tube surface and wherein the thickness of each tube is defined by the distance between said inner tube surface and said outer tube surface;
an outer shell formed by walls surrounding and defining therein a space for said second fluid to flow about and in contact with said outside surface of said plurality of elongated tubes which extend through said heat transfer space, said outer shell having at least one inlet opening in an inlet end portion for receiving said second fluid therethrough and at least one outlet opening in an outlet end portion for discharging said second fluid therethrough, said outer shell having an inner shell surface and an outer shell surface wherein the thickness of said outer shell is defined by the distance between said inner shell surface and said outer shell surface;
a first transverse member coupled to said inlet end portion of said inner shell surface of said outer shell for supporting the first end of each tube, said first transverse member defining a plurality of apertures for receiving a respective first end of a tube;
a second transverse member coupled to said outlet end portion of said inner shell surface of said outer shell for supporting the second end of each tube, said second transverse member defining a plurality of apertures for receiving a respective second end of a tube, wherein the wall thickness of at least one tube of the plurality of elongated tubes is thinner than the wall thickness of said outer shell or is made of an alloy of less resistance to corrosion than the alloy from which the shell is made.

31. A method for detecting corrosion in a heat exchanger for transferring heat between a first and second fluid comprising a plurality of elongated tubes for flow therethrough of said first fluid through said tubes, each tube having a first end and a second end, each of said tubes having an inner tube surface and an outer tube surface and wherein the thickness of each tube is defined by the distance between said inner tube surface and said outer tube surface;
an outer shell formed by walls surrounding and defining therein a space for said second fluid to flow about and in contact with said outside surface of said plurality of elongated tubes which extend through said heat transfer space, said outer shell having at least one inlet opening in an inlet end portion for receiving said second fluid therethrough and at least one outlet opening in an outlet end portion for discharging said second fluid therethrough, said outer shell having an inner shell surface and an outer shell surface wherein the thickness of said outer shell is defined by the distance between said inner shell surface and said outer shell surface;
a first transverse member coupled to said inlet end portion of said inner shell surface of said outer shell for supporting the first end of each tube, said first transverse member defining a plurality of apertures for receiving a respective first end of a tube;
a second transverse member coupled to said outlet end portion of said inner shell surface of said outer shell for supporting the second end of each tube, said second transverse member defining a plurality of apertures for receiving a respective second end of a tube, wherein the wall thickness of at least one tube of the plurality of elongated tubes is thinner than the wall thickness of said outer shell or is made of an alloy of less resistance to corrosion than the alloy from which the shell is made, said method comprising the steps of:
selecting at least one of said plurality of elongated tubes;
providing a seal at each of said first and second ends of said at least one selected tube to prevent flow of said first fluid therethrough and such that, during operation, the pressure inside the at least one selected tube will be different from the pressure inside said outer shell;
providing a channel from said outer surface of said outer shell through at least one of said first or second transverse members to the inner tube surface of said at least one selected tube such that said inner surface of said at least one selected tube is in fluid communication with said outer surface of said outer shell;
providing a pressure sensor in fluid communication with the inside of said at least one selected tube such that said pressure sensor will detect a change in the pressure inside said at least one selected tube once said at least one selected tube is penetrated by corrosion.

32. A method for detecting corrosion in a vessel formed of a predetermined material and containing corrosive process fluid comprising:
providing within the vessel a tube formed of substantially said predetermined material and having a wall thickness selected to allow corrosion caused by said corrosive process fluid to penetrate through said tube before the corrosion caused by the process fluid exceeds the corrosion allowance of the vessel;
pressurizing said tube;
providing a sensor for indicating the pressure in said tube
monitoring the pressure indicated by said sensor to detect corrosive breakthrough of said tube.
